(19) United States
(12) Patent Application Publication
(10) Pub. No.: US 2023/0064035 A1
(43) Pub. Date: Mar. 2, 2023

(54) Text-Based Video Re-take System and Methods

(71) Applicant: Shijian Tech (Hangzhou) Ltd., Hangzhou (CN)

(72) Inventors: Changyin Zhou, Hangzhou (CN); Fei Yu, Hangzhou (CN)

(21) Appl. No.: 17/822,513

(22) Filed: Aug. 26, 2022

(30) Foreign Application Priority Data
Aug. 26, 2021 (CN) 202110984882.X

(51) Int. Cl. G10L 15/26; H04N 21/845; G10L 15/187; G10L 25/63

(52) U.S. Cl. CPC G10L 15/26; H04N 21/8456; G10L 15/187; G10L 25/63

(57) ABSTRACT

The present disclosure describes systems and methods for audio/visual production. An example method includes capturing first video/audio during an initial video/audio capture session. The method also includes, during the initial video/audio capture session, determining at least one time stamp for each word spoken in the first video/audio. The method further includes, in response to receiving a retake request, selecting a cut point and a cut word. The cut word is spoken during or adjacent to the cut point. The method includes capturing second video/audio during a subsequent video/audio capture session. The method yet further includes cutting and merging a first clip from the first video/audio and a second clip from the second video/audio based on the cut point and the at least one time stamp corresponding to the cut word.

### CROSS-REFERENCE TO RELATED APPLICATIONS

The present application is a non-provisional patent application claiming priority to Chinese Patent Application No. 202110984882.X, filed Aug. 26, 2021, the contents of which are hereby incorporated by reference.

### BACKGROUND

Based in part on the broad availability of mobile computing devices (e.g., smartphones) and higher bandwidth network connection, video communications have become more common compared to those by way of images and texts. However, when capturing video content, recording errors are common. For example, errors could include incorrect wording, bad pronunciation, long pauses, improper facial expressions, gestures, eye contact or body language, or even forgetting the words to say. As a result, video recordings often have to be re-recorded many times and often edited together to combine the best parts of multiple video clips. It can be burdensome on hardware and memory to manage and store so many video clips. Furthermore, it is also hard to cut and merge those clips in a seamless fashion because they are often captured at different times, with different poses, etc. Accordingly, there is a need for improved narrative video recording and editing techniques.

### SUMMARY

The present disclosure describes systems and methods for audio/visual production.

In a first aspect, a method is described. The method includes capturing first video/audio during an initial video/audio capture session. The method also includes, during the initial video/audio capture session, determining at least one time stamp for each word spoken in the first video/audio. The method yet further includes, in response to receiving a retake request, selecting a cut point and a cut word. The cut word is spoken during or adjacent to the cut point. The method additionally includes capturing second video/audio during a subsequent video/audio capture session. The method also includes cutting and merging a first clip from the first video/audio and a second clip from the second video/audio based on the cut point and the at least one time stamp corresponding to the cut word.

In a second aspect, a system is described. The system includes a video/audio capture device and a realtime automatic speech recognition (ASR) module. The system also includes a re-take control module and an audio/textscript match and alignment engine. The system additionally includes a controller having a memory and at least one processor. The at least one processor is configured to execute instructions stored in the memory so as to carry out operations. The operations include causing the capture device to capture first video/audio during an initial video/audio capture session. The operations also include, during the initial video/audio capture session, causing the ASR module to determine at least one time stamp for each word spoken in the first video/audio. The operations yet further include, in response to receiving a retake request, causing the re-take control module to select a cut point and a cut word. The cut word is spoken during or adjacent to the cut point. The operations also include causing the capture device to capture second video/audio during a subsequent video/audio capture session. The operations additionally include causing the audio/textscript match and alignment engine to cut and merge a first clip from the first video/audio and a second clip from the second video/audio based on the cut point and the at least one time stamp corresponding to the cut word.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 illustrates a system, according to an example embodiment.

FIG. 2 illustrates a video/audio creation scenario.

FIG. 3 illustrates a video/audio creation scenario, according to an example embodiment.

FIG. 4 illustrates a flowchart of a video/audio creation scenario, according to an example embodiment.

FIG. 5 illustrates a flowchart of a video/audio creation scenario, according to an example embodiment.

FIG. 6 illustrates a display and user interface during various stages of a video/audio creation scenario, according to an example embodiment.

FIG. 7 illustrates a display and user interface during various stages of a video/audio creation scenario, according to an example embodiment.

FIG. 8 illustrates a display and user interface during various stages of a video/audio creation scenario, according to an example embodiment.

FIG. 9 illustrates a display and user interface during various stages of a video/audio creation scenario, according to an example embodiment.

FIG. 10 illustrates a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

In the present disclosure, systems and methods for multi-take video recording and editing are described. Specifically, some embodiments could relate to retaking audio or video recordings based on spoken text and/or a text script. In an example embodiment, the method includes: 1) Performing automatic speech recognition (ASR) to a live recorded video and align the resulting text from ASR with the video in real time; 2) Allow the user to trigger an immediate “Re-Take” session at an arbitrary time during the recording; 3) During the re-take session, the system switches to a control mode, where user determines the start and end of the video that would need to be re-taken based on the recognized text; 4) Provide audio/visual cues to the user so that the re-taken clip is more consistent to the original video; 5) After a re-take is done, seamlessly merge the newly recorded clip with the remaining part in real time, using a novel merging algorithm; 6) User can then continue audio/video recording.

The systems and methods described in the present disclosure may beneficially reduce or eliminate the need for users to cut and merge multiple-take video clips into a completed video. In some cases, the disclosed systems and methods may help users who are not very “tech-savvy” to more easily express their opinions via narrative videos.

### II. Example Systems

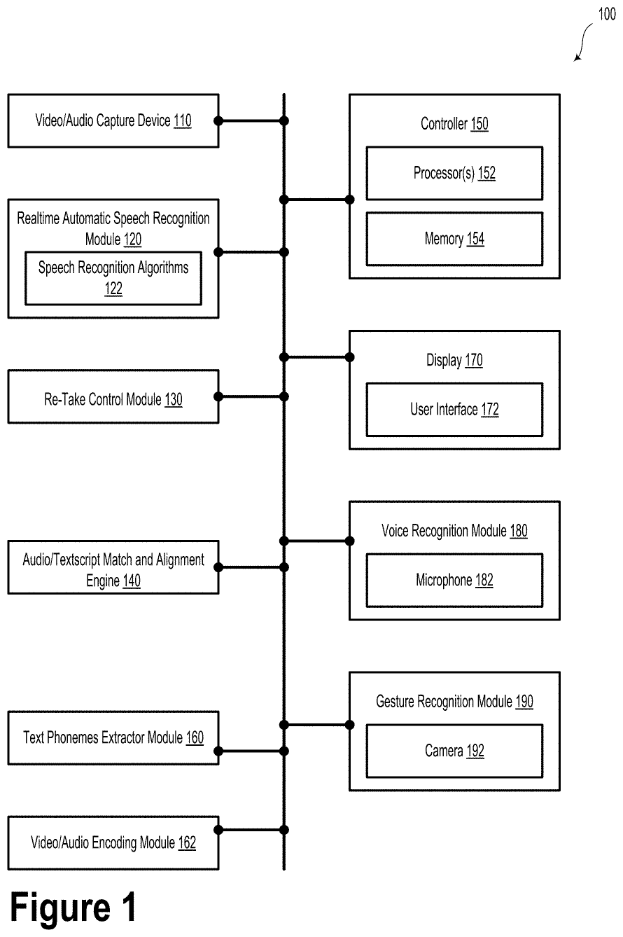

FIG. 1 illustrates a system 100, according to an example embodiment. System 100 includes a video/audio capture device 110. The video/audio capture device 110 could include one or more cameras associated with a computing device, such as a smartphone, a PC, a digital single-lens reflex (DSLR), or another type of video capture system.

The system 100 also includes a real-time automatic speech recognition (ASR) module 120. The ASR module 120 could be configured to accept as inputs raw audio wave data. Such data could include an audio stream or a video file with corresponding audio. It will be understood that the raw audio wave data could additionally or alternatively include a variety of video and/or audio file formats, such as HLS (HTTP Live Streaming), AVI (.avi), QuickTime (.mov), WebM (.webm), Windows Media Video (.wmv), Flash Video (.flv), and Ogg Video (.ogv). Other audio and video file formats are possible and contemplated.

The ASR module 120 could be configured to output recognized phonemes or symbols representing phonemes based on the input audio stream or video file. In some example embodiments, the phonemes could be recognized using a deep learning method or a Gaussian mixture model/Hidden Markov model (GMM-HMM). It will be understood that other models or algorithms for identifying different types of sounds from spoken audio or video clips are possible and contemplated.

The system 100 also includes a re-take control module 130. The re-take control module 130 could be configured to accept: 1) a control signal from user; and (2) alignment information indicative of a temporal alignment between spoken audio and a predetermined or dynamic textscript/transcript.

In such scenarios, the re-take control module 130 could be configured to: 1) output an adjusted portion of the video/audio obtained by capturing and splicing a retake video/audio segment; and 2) control the video/audio encoding module for exporting a smoothly edited and properly encoded video output.

The system 100 yet further includes an audio/textscript match and alignment engine 140. In an example embodiment, the audio/textscript match and alignment engine 140 may accept as inputs at least one of: 1) recognized phonemes or symbols representing phonemes (e.g., from the ASR module 120); or (2) textscript/transcript of the video/audio (e.g., a predetermined transcript or dynamic transcript).

The audio/textscript match and alignment engine 140 may be configured to output one or more exact timestamps associated with the start and/or end of every word in the video/audio and provide information about the temporal alignment between recognized phonemes and the predetermined or dynamic transcript.

In such scenarios, the audio/textscript match and alignment engine 140 could include a text phoneme extractor 160 to extract phoneme features from text script.

In various examples, the audio/textscript match and alignment engine 140 could utilize alignment dynamic programming and/or Hidden Markov Model (HMM)-based state transfer with predetermined and/or variable thresholds.

Additionally or alternatively, the system 100 may include a video/audio encoding module 162. In such scenarios, the video/audio encoding module 162 could be configured to accept as input: 1) raw audio input; 2) audio/textscript alignment result; and 3) a re-take control signal. In these examples, the video/audio encoding module 162 could be configured to output a full, automatically edited video with re-taken portions edited together in a smooth, automatic manner.

The system 100 additionally includes a controller 150, which has a memory 154 and at least one processor 152. The at least one processor 154 is configured to execute instructions stored in the memory 152 so as to carry out operations. In some example embodiments, the operations include causing the capture device 110 to capture first video/audio during an initial video/audio capture session.

The operations additionally include, during the initial video/audio capture session, causing the ASR module 120 to determine at least one time stamp for each word spoken in the first video/audio.

Yet further, the operations include, in response to receiving a retake request, causing the re-take control module 130 to select a cut point and a cut word. In some example embodiments, the cut word could be a word that is spoken during or adjacent to the cut point.

The operations also include causing the capture device 110 to capture second video/audio during a subsequent video/audio capture session.

The operations additionally include causing the audio/textscript match and alignment engine 140 to cut and merge a first clip from the first video/audio and a second clip from the second video/audio based on the cut point and the at least one time stamp corresponding to the cut word.

In some example embodiments, a predetermined transcript of the first video/audio could be provided to the audio/textscript match and alignment engine 140 prior to the initial video/audio capture session.

In various examples, the ASR module 120 could be configured to accept raw audio wave data and, based on the raw audio wave data, provide information indicative of recognized phonemes.

In example embodiments, the system 100 also includes a second ASR module. In such scenarios, the second ASR module is configured to generate a dynamic transcript of the first video/audio based on the raw audio wave data.

In various other example embodiments, the system 100 may additionally include a text phonemes extractor module 160. As an example, the text phonemes extractor module 160 could be configured to extract phoneme features from a predetermined transcript or a dynamic transcript of the first video/audio.

In some alternative embodiments, the ASR module 120 could be configured to execute speech recognition algorithms 122 based on at least one of: a hidden Markov model, a dynamic time warping model, a neural network model, a deep feedforward neural network model, a deep learning model, or a Gaussian mixture model/Hidden Markov model (GMM-HMM).

In various examples, the system 100 could also include a display 170. In such scenarios, the display 170 is configured to display 1) a portion of a predetermined transcript of the video/audio content; and/or 2) a cursor configured to be a temporal marker within the displayed portion of the predetermined transcript. In various embodiments, the display 170 may be configured to provide a user interface 172. As an example, the user interface 172 could provide a touchscreen, microphone, camera, and/or physical buttons that could enable ways for a user to interact with the system 100.

In some examples, system 100 may include a voice recognition module 180. The voice recognition module 180 could include at least one microphone 182. In such examples, the voice recognition module 180 could be configured to recognize at least one of: a retake request or a user control signal based on a voice command received via the microphone(s) 182.

In various embodiments, the system 100 may include a gesture recognition module 190. In some embodiments, the gesture recognition module 190 could include a camera 192 configured to provide still images and/or video information. In such scenarios, the gesture recognition module 190 is configured to recognize at least one of: a retake request or a user control signal based on a gesture determined by way of the still images and/or video information.

Yet further embodiments may include that the re-take control module is further configured to 1) control a display (e.g., display 170) to display a portion of the video/audio content and an overlaid, corresponding portion of text from a transcript of the video/audio content; or 2) control the display to gradually blend the displayed portion of the video/audio content and a live recording version of a re-take clip based on a desired cutting point.

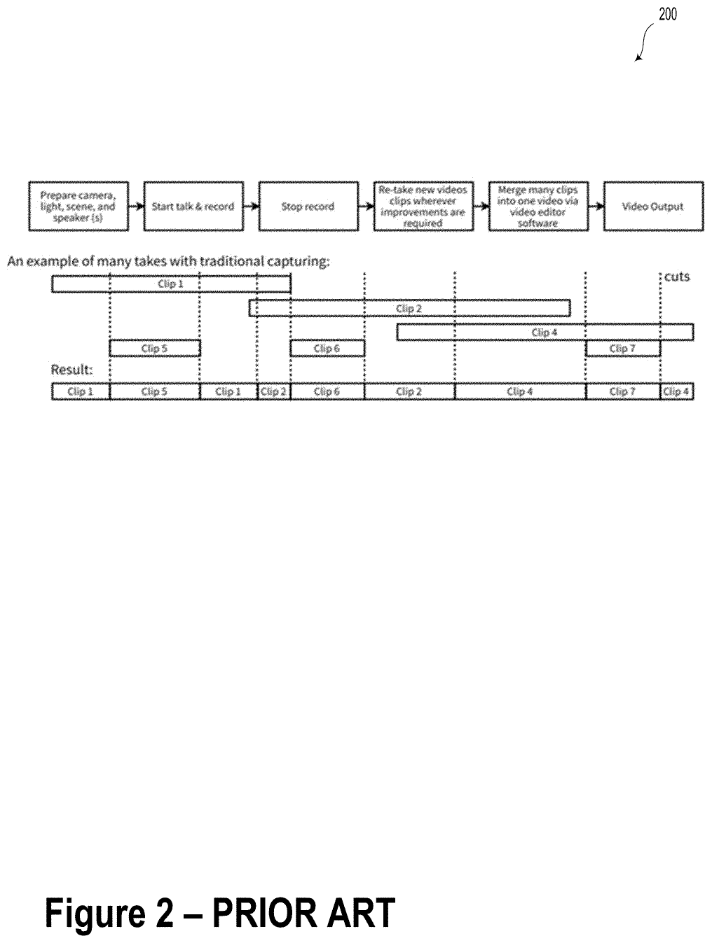

FIG. 2 illustrates a video/audio creation scenario 200. Video/audio creation scenario 200 represents a conventional method, in which multiple “takes” or clips may be recorded at several different times. After the clips are all captured, the cutting and merging of clips to complete a portion of completed video/audio content can be burdensome and/or time-consuming. Furthermore, it can be challenging to keep the transitions between clips smooth and natural.

In other words, whenever a user is unhappy with his/her performance during a capture session, there are the following options:

1. Stop the current recording, restart from the very beginning, and redo everything, or

2. Finish a complete recording first, and retake the portions wherever improvements are needed, or

3. Stop the current recording and save to a clip file, restart a new capture session from the beginning of the undesired portion, repeat the process if more undesirable issues occur, and once all capturing is completed, use a video editor to merge all clips into a single continuous video.

There are several challenges for such conventional methods. For example, such challenges may include finding the accurate cut time to restart video capture, automatically merging two video clips, designing easy operation steps to let user finish the process in a convenient way, among others.

To address such challenges, methods have been specifically developed for audio re-taking with a known timestamp alignment, such as when capturing vocalists singing a song. Under such methods, when a user wants to re-take part of the audio with known timestamps, like with a song recording where the timestamp for each word is relatively well-known, the system could let a user select the content to re-take, guide the user to re-take the content by playing previously recorded audio (e.g., a lead-in portion), or accompaniment audio (e.g., play non-vocal audio tracks or backing vocal tracks), etc. However, such methods make a strong assumption that the time range to be re-taken is known and fixed. This assumption does not necessarily apply to all narrative video/audio recordings (especially “short form” videos commonly shared via social media) and hence, such conventional methods are not applicable to most daily use cases.

The present disclosure describes various methods, systems, and related processes to provide users with a way to re-take unwanted parts of captured video/audio, merge several video clips together in an automatic and highly efficiently manner during the video shooting phase, instead of using post-processing video editing software to splice the clips together after the video capture phase. Such methods and systems may greatly reduce the challenges and costs involved in video capture and production. In addition, some example systems and methods may operate regardless of whether a predetermined transcript of the video/audio is provided. Also, various embodiments are provided to provide a way to merge different video clips together with seamless transitions.

The presently described systems and methods may provide: 1) a new way to capture and edit video content; 2) a new way to quickly an automatically select a cut point for editing videos; 3) a new way to merge different video clips automatically and in a way to make them seem as if they were captured in a “one-take” video capture session; and 4) a new user interface (UI) and/or user experience (UX) to achieve the above functions.

In example embodiments, systems and methods described herein may include several techniques, including Automatic Speech Recognition (ASR), Natural Language Processing (NLP), and a UI/UX workflow designed to specifically capture, cut, and smoothly merge multiple video clips. An example workflow may include:

1) When a user makes a mistake during a recording, the UI/UX provides a way to guide the user back in time in the video capture process to the beginning of the last sentence, or last few sentences so that the user can restart the recording to retake a “cleaner”, mistake-free version of the desired video/audio;

2) Through realtime transcription and visual cue feedback, the system may prompt the user with various forms of context of prior recording, including scripts and preview video portions, countdown timer display, countdown bar/clock, etc. The user may choose a cut or break point at which they would like to start a re-take of the video/audio;

3) When a user is ready to re-shoot and restart, the system provides a specific user flow to accurately restart from the desired break point;

4) Repeat steps 1-3 until the entire video is complete. In such scenarios, after the capture phase is complete, the user could export a full video shortly thereafter without additional video editing time;

5) Provide multiple other means to improve merging quality among different video clips at various break points.

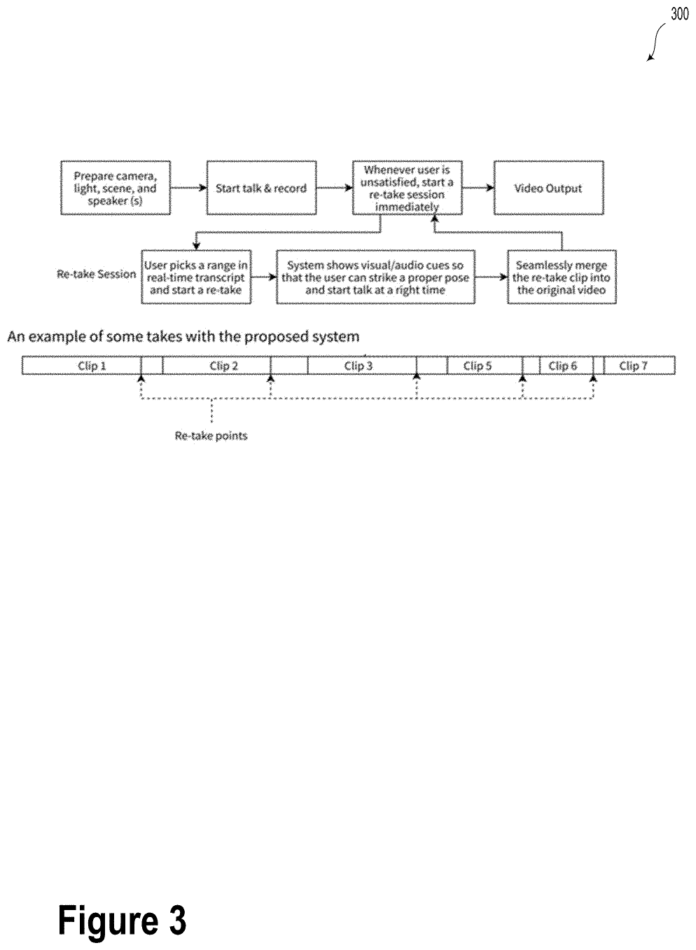

FIG. 3 illustrates a video/audio creation scenario 300, according to an example embodiment. Video/audio creation scenario 300 represents a text-based, real-time, re-take system and method to provide a way to combine multiple clips into one continuous shot. During a recording session, whenever an improvement or adjustment is needed (e.g., a word is mis-spoken, a cue is missed, etc.), a user can immediately trigger a re-take session. During the re-take session, audio and/or visual cues can be provided to help the user restart properly, and the system can merge the multiple takes in real-time, in an automatic, seamless fashion. No further cutting, merging, or other post-processing is required once the capturing process is completed.

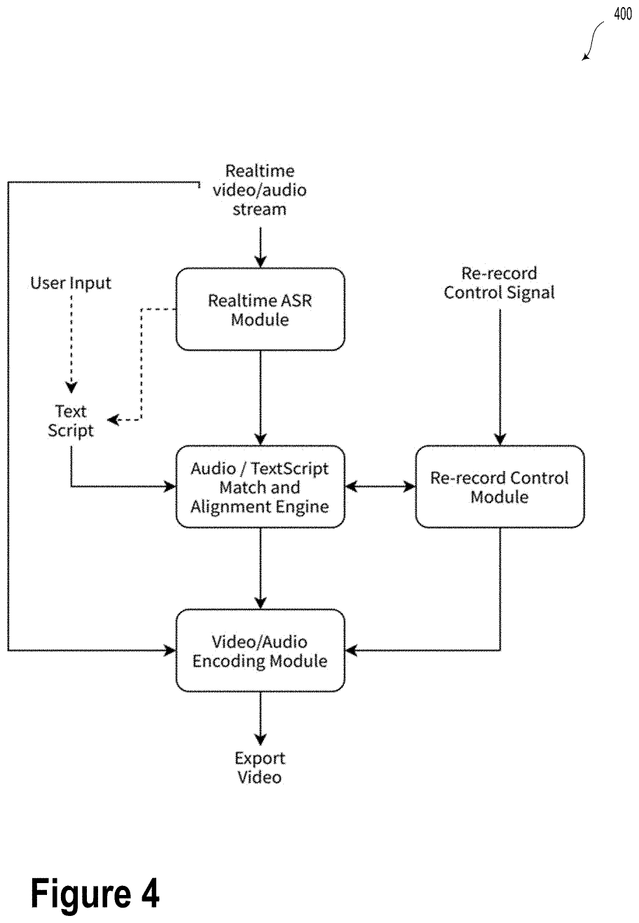

FIG. 4 illustrates a flowchart 400 of a video/audio creation scenario, according to an example embodiment. As illustrated in flowchart 400, in the case when a user provides a predetermined textscript or transcript for the video/audio, the system 100 will perform ASR and temporal alignment between the textscript and an input audio stream. When a user wants to re-take some part of the video (note it could be the last sentence or a sentence in the middle of the video), a user may perform certain actions (e.g., interact with a button icon of a graphical user interface, make a predetermined gesture, speak a predetermined verbal command, etc.) to set the system into a “control mode”. In such a control mode, the user could select or specify the beginning of the sentence that needs to be overwritten via the user interface 172. In response, system 100 could retrieve the responding beginning timestamp of the chosen sentence based on temporal alignment information provided by the audio/textscript match and alignment engine 140. Upon user confirmation of the re-take start point, system 100 may proceed to crop out portions of the video after the retrieved timestamp, and initiate a re-take capture session to capture video/audio starting from the selected timestamp. Alignment results are also updated accordingly.

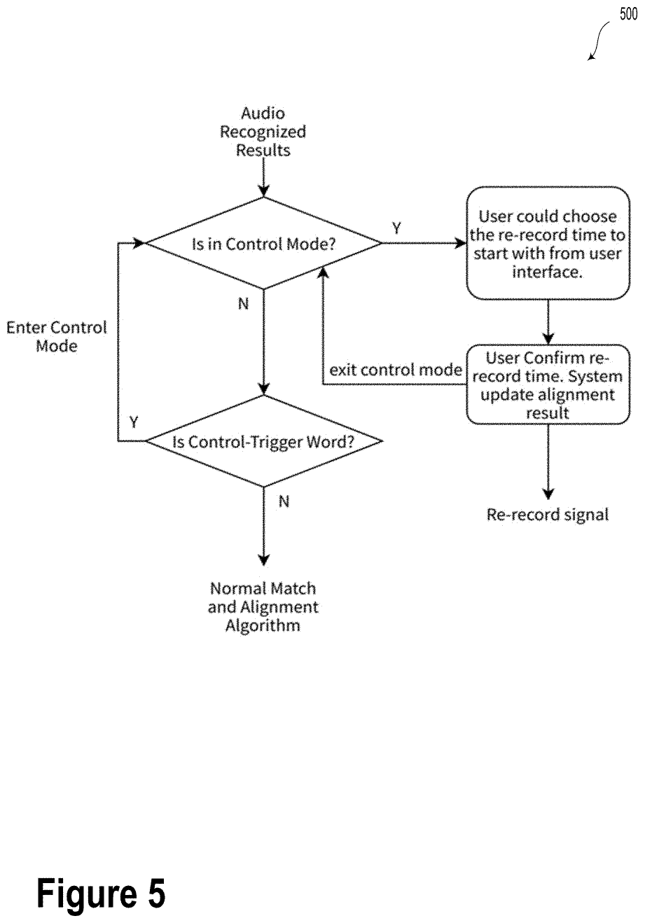

FIG. 5 illustrates a flowchart 500 of a video/audio creation scenario, according to an example embodiment. Flowchart 500 includes details about the re-take workflow as follows.

First, there are multiple ways for the system 100 to enter control mode:

1) User could press a button on the user interface 172 or press a button on a controller;

2) User could speak a specific trigger word or trigger phrase, like “OK, Vistring Recorder”; or

3) User could perform certain gestures, facial expressions, or actions.

While in control mode, video and audio encoding will be paused. User could perform multiple actions in such a mode, including:

1) Choose the start of a recorded sentence to be the re-take starting point; or

2) Change the shooting configurations, including setting camera lens parameters, camera distance, adjust background or change performer, etc.

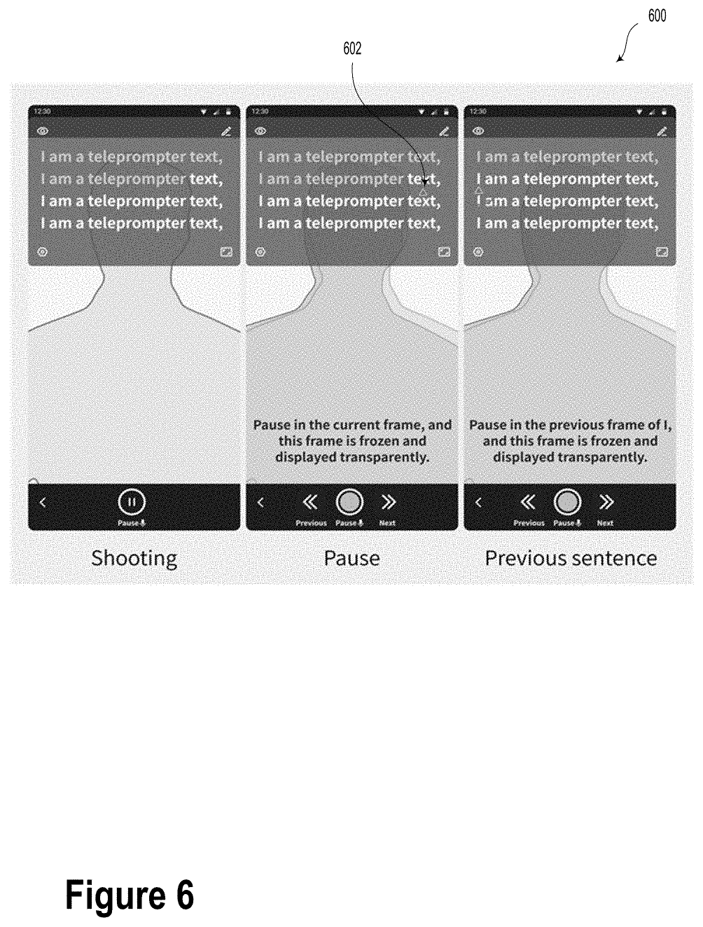

FIG. 6 illustrates a display and user interface screens 600 during various stages of a video/audio creation scenario, according to an example embodiment.

As illustrated in user interface screens 600, in some embodiments, the user interface 172 may provide information to assist the user in selecting the re-take starting point. For example, a red cursor 602 could indicate the currently-selected starting point for re-taking the video. Additionally or alternatively, button icons could be displayed on user interface 172 to adjust the current cursor “one sentence forward”/“next” and “one sentence backward”/“previous”. It will be understood that other ways to highlight or indicate the cut word or cut point are possible and contemplated. Additionally, it will be understood that other ways to adjust/manipulate the desired cut word or cut point are possible and contemplated.

Upon receiving user indication of a desire to re-take a portion of the video/audio, there are several ways to automatically determine the cursor location for the start of the sentence, cut word, and/or cut point:

1) by utilizing NLP technology, the start of the sentence could be determined and indicated;

2) utilizing punctuation marks in the predetermined or dynamic transcripts;

3) utilizing audio signal processing techniques, a relatively long silence during the audio recording may indicate desirable cut points and/or cut words.

To improve the efficiency of controlling the control state of the system, two or more operations could be bundled. For example, a voice command or a gesture could trigger both a first action to pause the recording and a second action to adjust the cursor go one sentence backward.

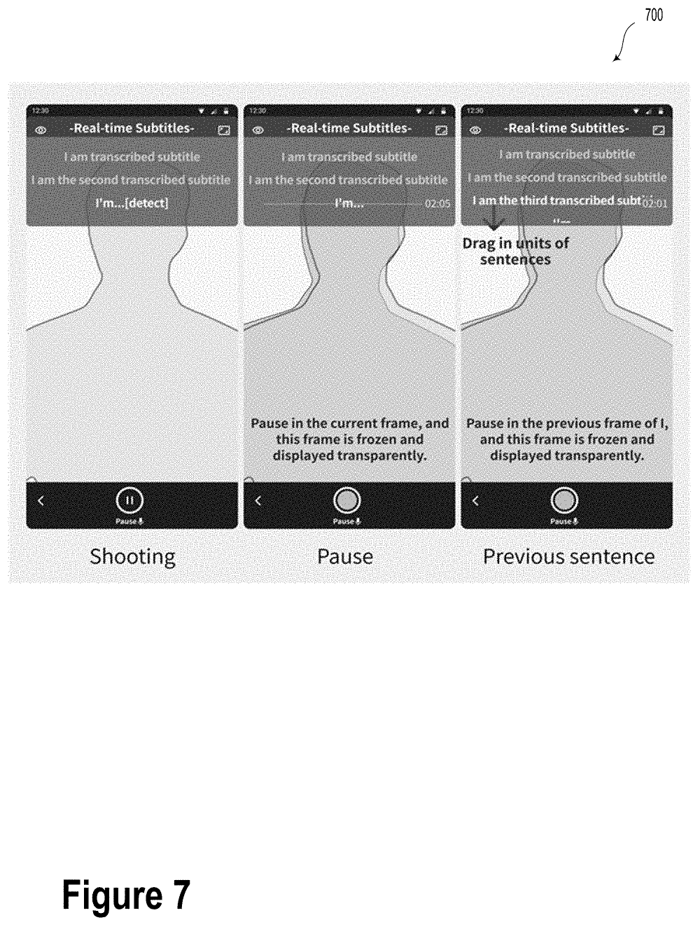

In some embodiments, a predetermined textscript or transcript for the video/audio need not be provided. Instead, the present systems and methods could utilize a second ASR module to output actual textscript (instead of phonemes) to provide a dynamic transcript that may be updated in real-time during the capture session. FIG. 7 illustrates a display and user interface screens 700 during various stages of a video/audio creation scenario without a predetermined transcript, according to an example embodiment. As illustrated on user interface screens 700, the user interface 172 could include dynamic subtitles based on the subject's speech. Upon receiving user input regarding a re-take request, the capture process could be paused and the user interface could adjust a position of the cursor (or other suitable visual indicator) to automatically show the default cut point/cut word.

Maintaining continuity while merging multiple clips into a single video is an important consideration. In such scenarios, both video and audio should be smoothly transitioned around the transition point between multiple clips. As described above, in conventional video workflows, video editing is performed in a phase subsequent to the shooting phase. Accordingly, it is very difficult to change the video content to make a combined video coherent and smooth during the capture phase. However, in the proposed systems and methods, users remain in the shooting phase and users may be guided to minimize the audio and visual differences between different video clips. Possible ways to improve continuity of videos at the break point are listed below:

1) User input to trigger a re-take and control mode could be accepted by way of voice recognition or gesture. Such scenarios would reduce or eliminate the need for the user to touch the touchscreen or physically interact with the user interface. As such, the user would not need to substantially move his/her body and would be able to substantially maintain a similar or identical body pose, lighting, etc. as that of the initial recording.

2) When a user re-takes a video, the present systems and methods could display via the user interface 172 video and/or still images recorded at or near the cut point. At the same time, there would be a displayed timer count down indicating the start of next recording. Yet further, the opacity of the picture obtained at the cut point decreases, while the opacity of real picture from current camera input, blended with the still picture above, increases. In this way, the user understands the previous recorded picture before the cutting point so that user could move or perform accordingly to minimize the difference of picture between before and after the cut point;

3) In some embodiments, when a user re-takes a video, the system shows a silhouette of the body to help the performer move to corresponding position;

4) To improve audio continuity between clips, when a user re-takes a video, the system may playback the previously recorded audio along with a display of a countdown timer, so that the user may get a preview to know when to start speaking by following the countdown;

5) In various embodiments, Deep Learning techniques could be utilized to generate several video frames/audio frames at the cutting point to help the video/audio to merge nicely together. Generation of interpolated or extrapolated frames based on the context of small differences in consecutives frame is possible and contemplated. Example techniques include utilizing a generative adversarial network (GAN) super frame technique. It will be understood that other ways to interpolate or extrapolate video image frames to smooth the transition between spliced video clips are possible and contemplated.

6) In the case where no predetermined transcript is provided, the process flow may be as follows: 1) upon receiving a user request for retake, newly transcribed text will be deleted; and 2) a video time may be provided for an indication of the start of the sentence.

In some example embodiments, the systems and methods described herein may support real-time video re-takes during a capture phase. Additionally or alternatively, example systems and methods could be utilized for a video re-taking tool for previously exported videos. The overall workflow is similar to above with minor changes.

1) gather textscript/transcript for the video;

2) perform ASR on the video, get the phonemon output and responding timestamps;

3) perform textscript/transcript and phonemon match and alignment;

4) user selects the start and end of the video clips to be re-taken based on text;

5) user re-takes a video clip as described above.

6) system automatically crops out the portions of the video with user interactions to end the video recording (e.g., hand gesture, verbal commands, user interaction with GUI, etc.).

7) system adjusts alignment result based on the newly inserted video since the length of the video could be different before and after the re-take video.

With regard to step 6, there are several ways to achieve this. A large body movement could be determined by a deep learning technique. Alternatively, a relatively long silence could signal an end of the video.

In some embodiments, capturing, storing, and merging the video clips could include the following:

1) when a recording pauses and the system enters control mode, save a video clip;

2) when a user requests a video re-take, save the previous video ending timestamp and create a new video clip for the newly recorded video clip;

3) repeat step 2 until the whole capture process is finished;

4) collect all recorded video clips and edit and merge those videos based on the cutting timestamp collected before.

In an effort to improve computing efficiency and ensure the processing could be performed in real-time, a novel algorithm is proposed as follows:

1) during the recording/capture phase, store the video in format of streaming media format, such as HTTP Live Streaming (HLS). This may naturally result in storing the captured videos clips in short segments with relatively small file sizes.

2) same as step 2 above,

3) same as step 3 above; and

4) merge the small video clips and update the playback sequence rule, like update HLS m3u8 file.

By utilizing HLS, proposed systems and methods may avoid large amounts of transcoding and may significantly increase computation capacity for other applications/uses.

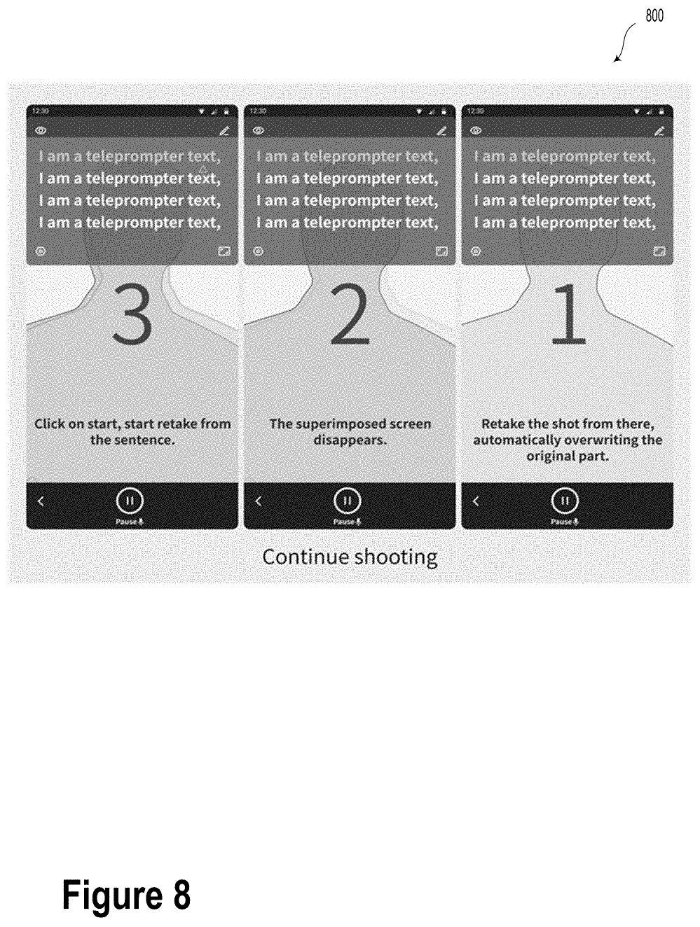

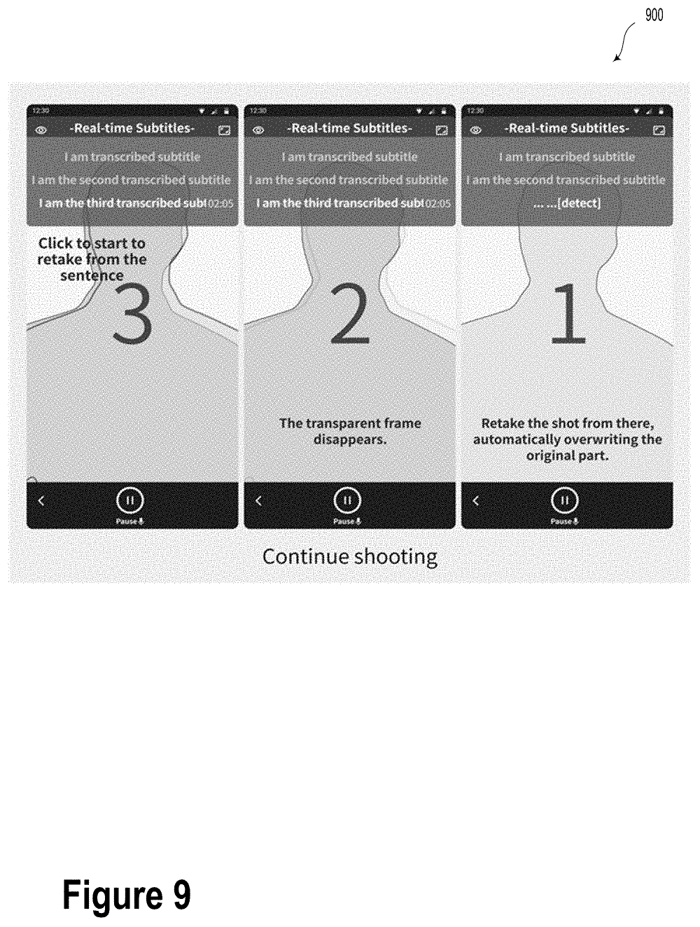

FIGS. 8 and 9 illustrate ways to utilize the user interface to help make two video clips look more coherent in a re-take scenario. As an example, a silhouette of the body could be displayed to help the performer move to an initial position corresponding to a prior position at or near the cut point. In some embodiments, the opacity of the silhouette could decrease along with the retake countdown and disappear when countdown reaches zero.

FIG. 8 illustrates a display and user interface screens 800 during various stages of a video/audio creation scenario, according to an example embodiment.

FIG. 9 illustrates a display and user interface screens 900 during various stages of a video/audio creation scenario, according to an example embodiment.

It will be noted that in various examples, systems and methods described herein could include providing user audio cues to help make the two video clips sound coherent after they merged together in a re-take scenario. As an example, a portion of the audio of the first video could be replayed during the retake timer count down so that the user could know when to start saying words once the re-take video clip is being captured.

### III. Example Methods

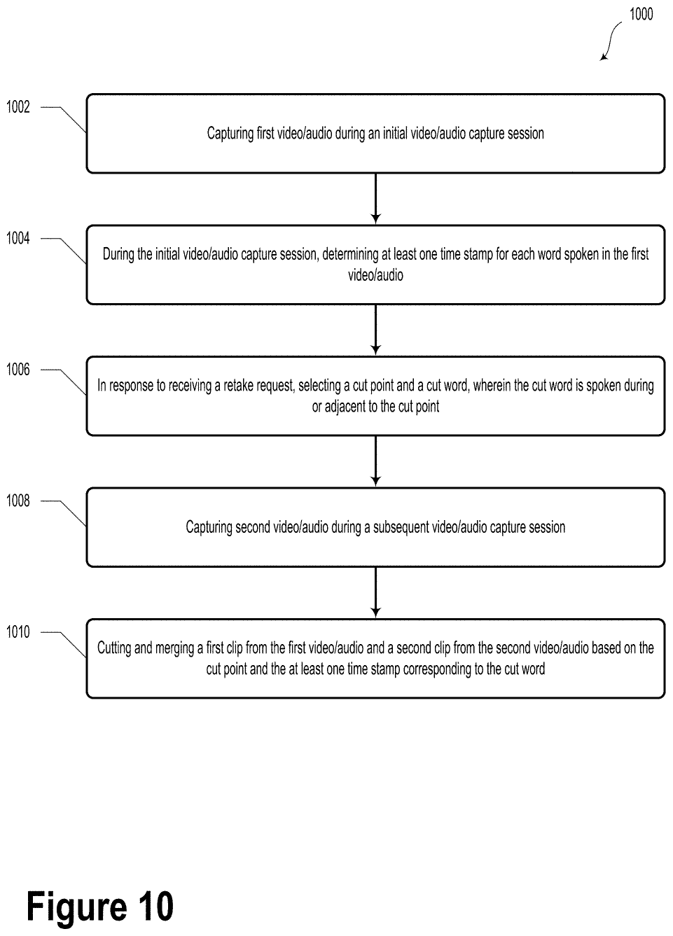

FIG. 10 illustrates a method 1000, according to an example embodiment. It will be understood that the method 1000 may include fewer or more steps or blocks than those expressly illustrated or otherwise disclosed herein. Furthermore, respective steps or blocks of method 1000 may be performed in any order and each step or block may be performed one or more times. In some embodiments, some or all of the blocks or steps of method 1000 may be carried out by controller 150 and/or other elements of system 100 as illustrated and described in relation to FIGS. 1 and 3-9.

Block 1002 includes capturing first video/audio during an initial video/audio capture session.

Block 1004 includes, during the initial video/audio capture session, determining at least one time stamp for each word spoken in the first video/audio.

Block 1006 includes, in response to receiving a retake request, selecting a cut point and a cut word. In such scenarios, the cut word is spoken during or adjacent to the cut point.

Block 1008 includes capturing second video/audio during a subsequent video/audio capture session.

Block 1010 includes cutting and merging a first clip from the first video/audio and a second clip from the second video/audio based on the cut point and the at least one time stamp corresponding to the cut word.

In some embodiments, determining the at least one time stamp for each word spoken in the first video/audio could be performed by utilizing realtime automatic speech recognition (ASR) modules and temporal alignment. In such scenarios, the ASR modules could include at least one of: a hidden Markov model, a dynamic time warping model, a neural network model, a deep feedforward neural network model, a deep learning model, or a Gaussian mixture model/Hidden Markov model (GMM-HMM).

In various examples, the determined at least one time stamp could include a start time and an end time for each word spoken in the video/audio.

In some examples, method 1000 may also include receiving a predetermined transcript by way of an audio/textscript match and alignment engine. In such scenarios, determining the at least one time stamp for each word spoken includes a comparison between the predetermined transcript and recognized phonemes in the first video/audio.

In other embodiments, method 1000 may additionally include generating a dynamic transcript based on raw audio wave data from the first video/audio. In such scenarios, determining the at least one time stamp for each word spoken includes a comparison between the dynamic transcript and recognized phonemes in the first video/audio.

In some example embodiments, cutting and merging the first clip and the second clip could include removing unwanted video/audio content. For instance, the unwanted video/audio content could include at least one of: incorrect spoken words, incorrect facial expression, incorrect body pose or gesture, incorrect emotion or tone of spoken words, incorrect pronunciation of spoken words, incorrect pace of spoken words, or incorrect volume of spoken words.

In some examples, cutting and merging the first clip and the second clip may include determining alignment information between the at least one time stamp corresponding to each word and at least one of: a predetermined transcript or a dynamic transcript. In such scenarios, the alignment information could include a time line with time differences based on a temporal comparison between the at least one time stamp corresponding to each word and at least one of: the predetermined transcript or the dynamic transcript.

In various embodiments, method 1000 could additionally include displaying, via a display, at least a portion of a predetermined transcript.

Additionally or alternatively, the method block of receiving a retake request could include determining a user control signal based on at least one of: user interface interaction, a voice command, or a gesture.

It will be understood that various ways to smooth transitions between original and retaken video clips are possible and contemplated. In some examples, audio and/or visual cues could be provided to the user/performer to indicate a recommended body position, speaking cadence, speaking volume, speaking transcript, etc.

As an example, method 1000 may include, prior to capturing the second video/audio, providing, via a display, a countdown indicator. In such scenarios, the countdown indicator includes a series of countdown numerals, a countdown bar, or a countdown clock. The countdown indicator could help provide information indicative of the amount of time until the start of the capturing of the second video/audio.

In some example embodiments, the method 1000 may additionally include at least one of: 1) prior to capturing the second video/audio, playing back a portion of audio of the first video/audio while the countdown indicator is active so as to provide an audio cue to a performer; or 2) prior to capturing the second video/audio, displaying, via the display, a silhouette of a body so as to provide a body position cue to a performer, wherein an opacity of the silhouette decreases to zero as the countdown indicator elapses. It will be understood that other ways to provide cues to a performer in an effort to achieve continuity across re-take clips are possible and contemplated.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A method comprising:
capturing first video/audio during an initial video/audio capture session;
during the initial video/audio capture session, determining at least one time stamp for each word spoken in the first video/audio;
in response to receiving a retake request, selecting a cut point and a cut word, wherein the cut word is spoken during or adjacent to the cut point;
capturing second video/audio during a subsequent video/audio capture session; and
cutting and merging a first clip from the first video/audio and a second clip from the second video/audio based on the cut point and the at least one time stamp corresponding to the cut word.

2. The method of claim 1, wherein determining the at least one time stamp for each word spoken in the first video/audio is performed by utilizing realtime automatic speech recognition (ASR) modules and temporal alignment.

3. The method of claim 2, wherein the ASR modules comprise at least one of: a hidden Markov model, a dynamic time warping model, a neural network model, a deep feedforward neural network model, a deep learning model, or a Gaussian mixture model/Hidden Markov model (GMM-HMM).

4. The method of claim 1, further comprising:
receiving a predetermined transcript by way of an audio/textscript match and alignment engine, wherein determining the at least one time stamp for each word spoken comprises a comparison between the predetermined transcript and recognized phonemes in the first video/audio.

5. The method of claim 1, further comprising:
generating a dynamic transcript based on raw audio wave data from the first video/audio, wherein determining the at least one time stamp for each word spoken comprises a comparison between the dynamic transcript and recognized phonemes in the first video/audio.

6. The method of claim 1, wherein cutting and merging the first clip and the second clip comprises removing unwanted video/audio content, wherein the unwanted video/audio content comprises at least one of: incorrect spoken words, incorrect facial expression, incorrect body pose or gesture, incorrect emotion or tone of spoken words, incorrect pronunciation of spoken words, incorrect pace of spoken words, or incorrect volume of spoken words.

7. The method of claim 1, wherein cutting and merging the first clip and the second clip comprises determining alignment information between the at least one time stamp corresponding to each word and at least one of: a predetermined transcript or a dynamic transcript, wherein the alignment information comprises a time line with time differences based on a temporal comparison between the at least one time stamp corresponding to each word and at least one of: the predetermined transcript or the dynamic transcript.

8. The method of claim 1, wherein receiving a retake request comprises determining a user control signal based on at least one of: user interface interaction, a voice command, or a gesture.

9. The method of claim 1, further comprising:
prior to capturing the second video/audio, providing, via a display, a countdown indicator, wherein the countdown indicator comprises a series of countdown numerals, a countdown bar, or a countdown clock, wherein the countdown indicator provides information indicative of the amount of time until the start of the capturing of the second video/audio.

10. The method of claim 9, further comprising at least one of:
prior to capturing the second video/audio, playing back audio of the first video/audio while the countdown indicator is active so as to provide an audio cue to a performer; or
prior to capturing the second video/audio, displaying, via the display, a silhouette of a body so as to provide a body position cue to a performer, wherein an opacity of the silhouette decreases to zero as the countdown indicator elapses.

11. A system comprising:
a video/audio capture device;
a realtime automatic speech recognition (ASR) module;
a re-take control module;
an audio/textscript match and alignment engine; and
a controller having a memory and at least one processor, wherein the at least one processor is configured to execute instructions stored in the memory so as to carry out operations, the operations comprising:
causing the capture device to capture first video/audio during an initial video/audio capture session;
during the initial video/audio capture session, causing the ASR module to determine at least one time stamp for each word spoken in the first video/audio;
in response to receiving a retake request, causing the re-take control module to select a cut point and a cut word, wherein the cut word is spoken during or adjacent to the cut point;
causing the capture device to capture second video/audio during a subsequent video/audio capture session; and
causing the audio/textscript match and alignment engine to cut and merge a first clip from the first video/audio and a second clip from the second video/audio based on the cut point and the at least one time stamp corresponding to the cut word.

12. The system of claim 11, wherein a predetermined transcript of the first video/audio is provided to the audio/textscript match and alignment engine prior to the initial video/audio capture session.

13. The system of claim 11, wherein the ASR module is configured to accept raw audio wave data and, based on the raw audio wave data, provide information indicative of recognized phonemes.

14. The system of claim 13, further comprising a second ASR module, wherein the second ASR module is configured to generate a dynamic transcript of the first video/audio based on the raw audio wave data.

15. The system of claim 11, further comprising a text phonemes extractor module, wherein the text phonemes extractor module is configured to extract phoneme features from a predetermined transcript or a dynamic transcript of the first video/audio.

16. The system of claim 11, wherein the ASR module is configured to execute speech recognition algorithms based on at least one of: a hidden Markov model, a dynamic time warping model, a neural network model, a deep feedforward neural network model, a deep learning model, or a Gaussian mixture model/Hidden Markov model (GMM-HMM).

17. The system of claim 11, further comprising a display, wherein the display is configured to display a portion of a predetermined transcript of the video/audio content and a cursor configured to be a temporal marker within the displayed portion of the predetermined transcript.

18. The system of claim 11, further comprising a voice recognition module, wherein the voice recognition module is configured to recognize at least one of: a retake request or a user control signal based on a voice command.

19. The system of claim 11, further comprising a gesture recognition module, wherein the gesture recognition module is configured to recognize at least one of: a retake request or a user control signal based on a gesture.

20. The system of claim 11, wherein the re-take control module is further configured to:
control a display to display a portion of the video/audio content and an overlaid, corresponding portion of text from a transcript of the video/audio content; or
control the display to gradually blend the displayed portion of the video/audio content and a live recording version of a re-take clip based on a desired cutting point.
